(19) United States
(12) Patent Application Publication
(10) Pub. No.: US 2006/0014878 A1
(43) Pub. Date: Jan. 19, 2006

(54) Polymer concrete

(75) Inventor: Gerardus Maria Van Erp, Toowoomba (AU)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: The University of Southern Queensland, Toowoomba (AU)

(21) Appl. No.: 10/534,939

(22) PCT Filed: Nov. 13, 2003
(86) PCT No.: PCT/AU03/01520

§ 371 Date: Jun. 15, 2005

(30) Foreign Application Priority Data
Nov. 13, 2002 (AU) 2002952619
Aug. 18, 2003 (AU) 2003904407

(51) Int. Cl. C08K 3/34; C08K 3/00

(52) U.S. Cl. 524/442; 524/2

(57) ABSTRACT

A polymer concrete formulation comprising an amount of polymer resin; an amount of thixotrope; an amount of a light aggregate with a specific gravity less than that of the resin; and an amount of a heavy aggregate with a specific gravity larger than that of the resin.

### FIELD OF THE INVENTION

This invention relates to polymer concrete. In particular, the invention resides in polymer concrete that is used to produce structural elements.

### BACKGROUND OF THE INVENTION

Developments in civil engineering and the building industry have created a continual demand for building materials with new and improved performance attributes. Polymer concretes appear to offer possibilities for meeting these new requirements.

Polymer concrete consists of aggregates bonded together by a resin binder instead of water and cement binder that are used in standard cement concrete. Polymer concrete has generally good durability and chemical resistance and is therefore used in various applications such as in pipes, tunnel supports, bridge decks and electrolytic containers. The compressive and tensile strength of polymer concrete is generally significantly higher than that of standard concrete. As a result polymer concrete structures are generally smaller and significantly lighter than equivalent structures made out of standard concrete. Additional advantages of polymer concrete include very low permeability and very fast curing times.

The biggest disadvantage of polymer concrete is its cost. Resin is significantly more expensive than cement and water and to be cost effective resin content is generally reduced as much as possible. However, it is the resin that binds the aggregates together and gives the polymer concrete its strength. Polymer concrete with low resin content generally results in a brittle product with low tensile strength. Further, the resin content also determines the overall viscosity of the polymer concrete formulation. Polymer concrete with low resin content is generally very dry and difficult to work with.

As with standard concrete, the gradation of the aggregate for polymer concrete is based on the particle size of the different aggregate components. The particle size of the different aggregate components is chosen such that maximum packing of the overall aggregate is obtained. This maximum packing results in a minimum amount of remaining voids within the overall aggregate which have to be filled with resin. Hence maximum packing results in the minimum amount of resin that is required in the polymer concrete formulation.

A limitation of traditional polymer concrete is that it is very difficult to get a controlled variation of structural properties throughout a specific product. Many structural products have specific areas that require high compression strength and other areas that require high tensile strength.

As with standard concrete, polymer concrete structures often require reinforcement. Traditional steel reinforcement bars can be used, but as polymer concrete is often used in corrosive environments, continuous fibre composite reinforcement is generally preferred. Most continuous fibre composite reinforcement relies on adhesion between the polymer concrete and the reinforcement to transfer forces. In dry polymer concrete formulations there is often not enough resin in the mix to achieve the necessary level of adhesion and hence the fibre composite reinforcement has to be provided with a physical anchorage such as ribs. As most continuous fibre composite reinforcement is produced using the pultrusion process, incorporation of ribs or other forms of physical anchorage is difficult and expensive.

### OBJECT OF THE INVENTION

It is an object of the invention to overcome or alleviate one or more of the disadvantages of the above disadvantages or provide the consumer with a useful or commercial choice.

It is a preferred object of this invention to enable polymer concrete to be produced with a controlled variation of the density throughout the final product.

It is a further preferred object of this invention to enable polymer concrete to be produced with a controlled variation of the resin content throughout the final product.

It is a still further preferred object of the invention to enable polymer concrete to be produced with controllable flowability and excellent workability.

It is a still further preferred object of the invention to enable polymer concrete to be produced cost effectively.

It is a still further preferred object of the invention to allow structural elements made of polymer concrete to be produced with a significantly reduced weight.

### SUMMARY OF THE INVENTION

In one form, although not necessarily the only or broadest form, the invention resides in a polymer concrete formulation comprising:

an amount of polymer resin;

an amount of thixotrope;

an amount of a light aggregate with a specific gravity less than that of the resin; and

an amount of a heavy aggregate with a specific gravity larger than that of the resin.

The resin may be any suitable polyester, vinylester, epoxy or polyurethane resin or combination of resins dependent on the desired structural and corrosion resistant properties of the polymer concrete. Preferably, the resin content is between 25-30% by volume.

The light aggregate with a specific gravity less than that of the resin can be any type of light aggregate or combination of light aggregates dependent on the desired structural and corrosion resistant properties of the polymer concrete. Usually, the light aggregates have a specific gravity of 0.5 to 0.9. Preferably, the light aggregate has a specific gravity that is close to the specific gravity of the resin. The light aggregates usually make up 20-25% by volume of the polymer concrete. Preferably, the light aggregate are centre spheres. The centre spheres normally have a specific gravity of approximately 0.7 and are 20-300 microns in size. Alternately, hollow glass microspheres with a similar specific gravity and volume may be used.

The heavy aggregate with a specific gravity larger than that of the resin can be any type of heavy aggregate or combination of heavy aggregates dependent on the desired structural and corrosion resistant properties of the polymer concrete. The heavy aggregates usually make up 40-60% by volume of the polymer concrete.

Preferably the heavy aggregate is basalt. Usually the basalt is crushed. The crushed basalt may have a particle size 5 to 7 mm. Preferably the basalt makes up between 40-50% by volume of the polymer concrete. The basalt normally has a specific gravity of approximately 2.8. Alternately, sand that has a similar specific gravity as basalt may be used. Preferably the sand makes up between 50-60% by volume of the polymer concrete.

Alternatively, the heavy aggregate may be made up of one or more of coloured stones, gravel, limestone, shells, glass or the like material.

Preferably the resin contains a thixotrope to keep the light aggregate in suspension. The amount of thixotrope is normally between 0.5% to 1% of the resin weight. Preferably, the thixotrope is fumed silica such as found in Cabosil or Aerosil.

The polymer concrete of the present invention may also include fibrous reinforcement material to increase the structural properties of the polymer concrete mix. The reinforcement material may be glass, aramid, carbon, timber and/or thermo plastic fibres.

In another form, the invention resides in a method of forming a structural element using polymer concrete, the polymer concrete having an amount of polymer resin, an amount of thixotrope, an amount of a light aggregate with a specific gravity less than that of the resin; and an amount of a heavy aggregate with a specific gravity larger than that of the resin, the method including the steps of:

choosing an amount of resin;

choosing an amount of thixotrope;

choosing an amount of light aggregate to obtain the desired viscosity of the resin-light aggregate mix

choosing an amount of heavy aggregate to form a desired thickness of a lower layer within the structural element;

mixing the resin, thixotrope, heavy aggregate and light aggregate together to form polymer concrete;

locating the polymer concrete in a mould;

allowing the polymer concrete to settle to form a first layer and a second layer of different consistency within the structural element;

removing the structural element from the mould.

Reinforcement members may be located within the polymer concrete after the polymer concrete has settled. The reinforcement member may be located in the second layer of the structural element.

The reinforcement member may have a series of apertures located through the reinforcement member. Thus, the reinforcement member may allow resin and light aggregate to pass through the apertures.

An additional mixture of resin and light aggregate may be located on top of the reinforcement member.

A top surface of the first layer may be polished to provide an aesthetically appealing top surface.

In yet another form, the invention resides in a structural element comprising:

a first layer of:
an amount of polymer resin;
an amount of a light aggregate with a specific gravity less than that of the resin; and
an amount of a heavy aggregate with a specific gravity larger than that of the resin and;

a second layer of:
an amount of polymer resin; and
an amount of a light aggregate with a specific gravity less than that of the resin.

One or more reinforcement members may be located within the structural element. Normally, the reinforcement members are located between the first layer and the second layer. The reinforcement member may have a series of apertures located through the reinforcement member. The apertures may be sized to allow resin and an amount of light aggregate to pass through the apertures.

### BRIEF DESCRIPTION OF THE DRAWINGS

Embodiments of the invention will be described with reference to the accompanying drawings in which:

FIG. 1 is a perspective view of a marine beam produced in accordance with a first embodiment of the invention;

FIG. 2A is a front view showing the first step in producing the marine beam of FIG. 1;

FIG. 2B is a front view showing the second step in producing the marine beam of FIG. 1;

FIG. 2C is a front view showing the third step in producing the marine beam of FIG. 1;

FIG. 2D is a front view showing the fourth step in producing the marine beam of FIG. 1;

FIG. 3 is a perspective view of a bench top produced in accordance with a second embodiment of the invention;

FIG. 4A is a front view showing the first step in producing the bench top of FIG. 3;

FIG. 4B is a perspective view showing the first step in producing the bench top of FIG. 3;

FIG. 5A is a front view showing the first step in producing the bench top of FIG. 3;

FIG. 5B is a perspective view showing the first step in producing the bench top of FIG. 3;

FIG. 6A is a front view showing the first step in producing the bench top of FIG. 3;

FIG. 6B is a perspective view showing the first step in producing the bench top of FIG. 3;

FIG. 7A is a front view showing the first step in producing the bench top of FIG. 3;

FIG. 7B is a perspective view showing the first step in producing the bench top of FIG. 3;

FIG. 8A is a front view showing the first step in producing the bench top of FIG. 3; and

FIG. 8B is a perspective view showing the first step in producing the bench top of FIG. 3.

### DETAILED DESCRIPTION OF THE PREFFERED EMBODIMENT

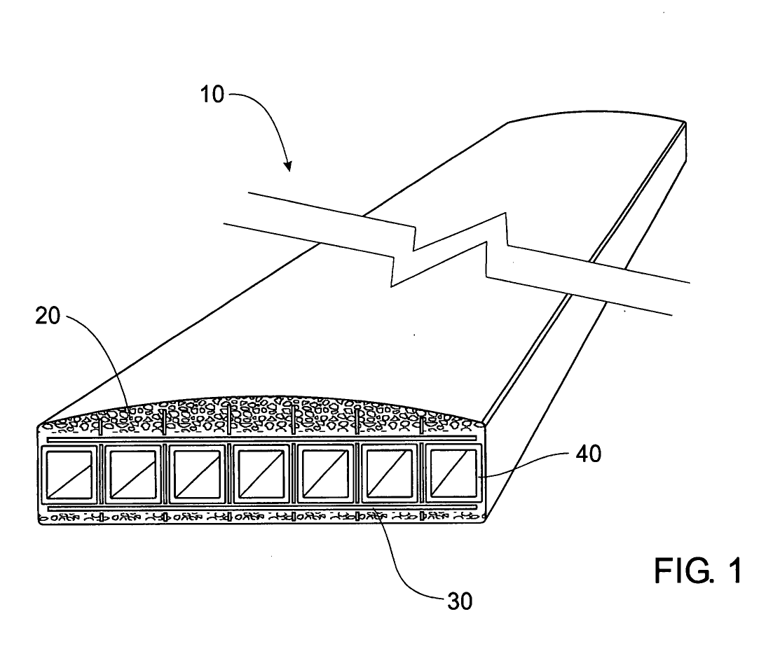

FIG. 1 shows a marine beam 10 formed using polymer concrete 20, flat composite fibre reinforcing members 30 and tubular composite fibre reinforcing members 40.

The polymer concrete 20 is formed with approximately 28% by volume of resin including a fumed silica that is 0.8% of the weight of the resin, 22% by volume of light aggregate and 50% by volume of heavy aggregate.

The light aggregate is in the form of centre spheres having a specific gravity of approximately 0.7 The heavy aggregate is formed from crushed basalt having a specific gravity of approximately 2.8 and a particle size of 5-7 mm.

The light aggregate has a specific gravity that is slightly less than that of the resin whilst the heavy aggregate has a specific gravity that is larger than that of the resin.

A thixotrope is added to the resin so that the light aggregate will stay in suspension within the resin and hence will be substantially unfirmly distributed throughout the polymer concrete. Consequently, the resin together with the lighter aggregate in suspension becomes a flowable filled resin system in its own right. The amount of the lighter aggregate suspended in the resin can be varied as required.

The heavy aggregate, which is heavier than the resin, sinks to the bottom of the polymer concrete and can as such be positioned in certain parts of the final product. By adding the heavier aggregate in specific amounts during the pour, layers or areas of polymer concrete with different amounts of aggregate and hence different density and structural properties can be obtained.

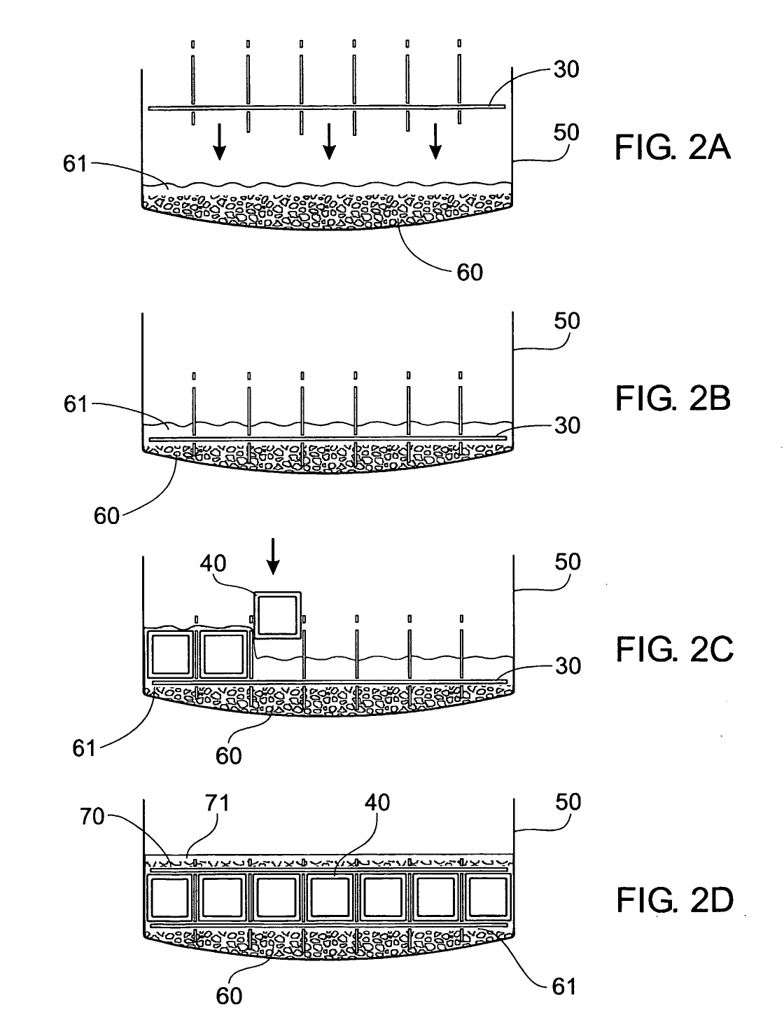

FIGS. 2A to 2D show the process that is used to produce the marine beam 10 shown in FIG. 1. The first step in the process is to produce formwork of a desired shape to form a mould 50. In this example, the marine beam 10 is produced in an upside down manner.

Polymer concrete is mixed and poured into the mould and allowed to sit. The heavy aggregate settles to the bottom of the mould. The amount of aggregate is chosen such that once the aggregate has settled, a lower aggregate layer 60 will stop approximately 10 mm below the surface of the polymer concrete. The lower layer contains resin, thixotrope, light aggregate and heavy aggregate. Consequently there is a 10 mm upper layer 61 of resin, thixotrope and light aggregate on top of the lower layer 60 of the polymer concrete that is aggregate rich. Because there is no heavy aggregate in the upper 61 layer, the resin content in this layer is 56% by volume and the light aggregate in suspension in this layer is 44% by volume.

Individual flat fibre composite reinforcement members 30 and tubular fibre reinforcement members 40 are then located in the mould in the upper layer. The resin and light aggregate of upper layer 60 surrounds the flat reinforcement members and the tubular composite reinforcement members as shown in FIG. 2C. This resin and light aggregate of the upper layer provide excellent adhesion for the tubular fibre composite reinforcement bars.

Additional polymer concrete is than added to the mould as shown in FIG. 2D. The heavier aggregate again settles on top of the tubular reinforcement elements to form a lower layer 70, leaving a thin upper layer 71 of the filled resin mix near the top of the mould 150. The upper layer 71 is then screeded without interference of the heavy aggregate that is not located within the upper layer. The polymer concrete is then allowed to cure and the marine beam is removed from the mould 10.

The marine beam has high compressive strength areas where there is a high heavy aggregate content and high tensile strength areas where there is increased resin content together with reduced aggregate loading. In this manner, the structural properties can be varied throughout the marine beam to achieve a desired structural result.

It should be appreciated that the techniques used to produce the variations in structural properties for the marine beam maybe used on other structural elements.

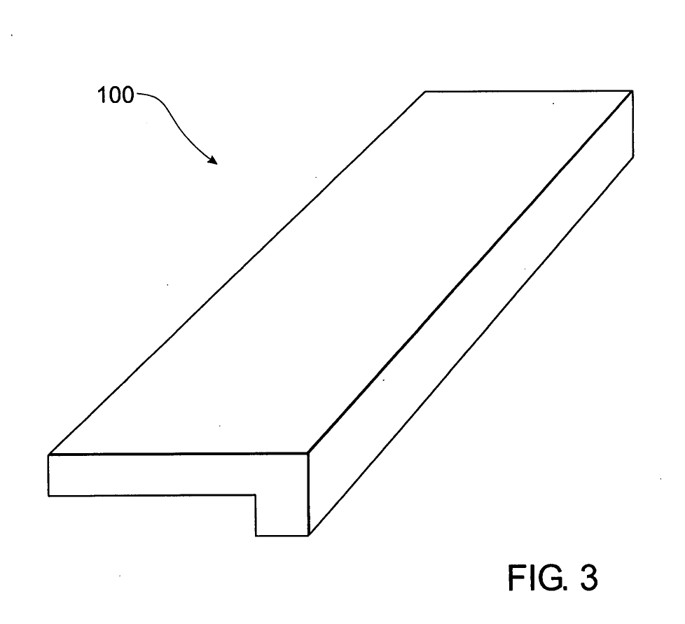

FIG. 3 shows a bench top 100 formed using polymer concrete 120 and a timber reinforcement member 130.

The polymer concrete 120 is same polymer concrete used to produce the marine beam of FIG. 1.

The timber reinforcement member 130 is a marine ply sheet having a series of apertures 131 that extend through the sheet marine ply sheet. The apertures 131 are formed by drilling holes through the marine ply sheet.

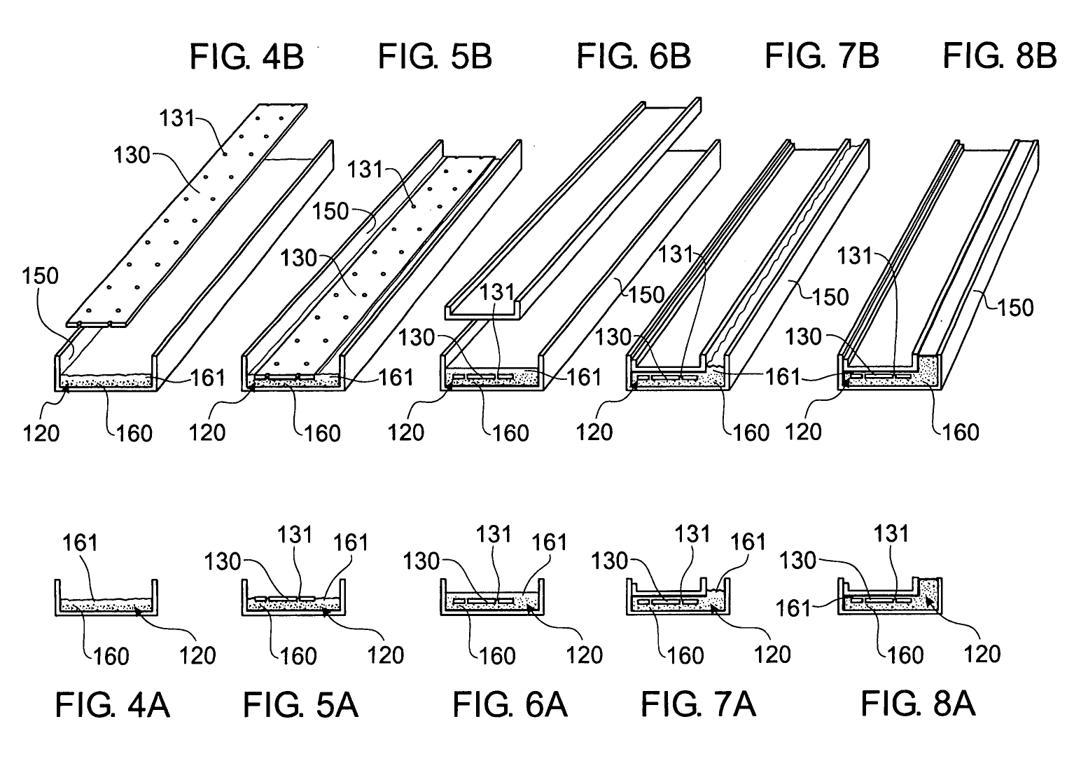

FIGS. 4A to 8A and FIGS. 4B to 8B show the process used to produce the bench top 100 shown in FIG. 3. The first step in the process is to produce mould 150 of a desired shape of the bench top 100. In this example, the bench top 100 is produced in an upside down manner.

Polymer concrete is mixed and poured into the mould 150 and allowed to sit as shown in FIGS. 4A and 4B. The heavy aggregate settles in the bottom of the mould 150. The amount of aggregate is chosen such that once the aggregate has settled, a lower aggregate layer 160 will stop approximately 10 mm below the surface of the polymer concrete. Consequently there is a 10 mm upper layer 161 of resin and light aggregate on top of the lower layer 160 of the polymer concrete that is aggregate rich. Because there is no heavy aggregate in the upper 161 layer, the resin content in this layer is 56% by volume and the light aggregate in suspension in this layer is 44% by volume.

FIGS. 5A and 5B shows the timber reinforcement member 130 placed on top of the upper layer 161 containing only light aggregate and resin. Pressure is applied to the timber reinforcement member 130 until the timber reinforcement member 131 contacts the lower layer of resin, light aggregate and heavy aggregate. Subsequently, the light aggregate and resin located in the upper layer 161 passes through the apertures located within the timber reinforcement member. An additional mixture of resin and light aggregate, the resin content being 56% by volume and the light aggregate content being 44% by volume, may be poured on top of the timber reinforcement member 130. This is necessary if the timber reinforcement member 130 is not fully covered by the light aggregate and resin in the upper layer 131. The timber reinforcement member 130 is shown covered by the light aggregate and resin in FIGS. 6A and 6B.

A top of the mould is then placed on the upper layer that covers the timber reinforcement member as shown in FIGS. 7A and 7B. A side of the top mould is open and additional polymer concrete is placed into the side of the top of the mould to complete the forming process of the bench top 100. The bench top 100 is allowed to cure and then removed from the mould. The bench top 100 is then polished to complete the bench top.

The bench top 100 combines a special polymer concrete formulation with a two dimensional reinforcement system that provides the bench top 100 with the necessary structural capacity. The bench top 100 can be connected to other elements or support structures using traditional fastening systems such as screws and nails. The timber reinforcement member 130 and the cured layer of light aggregate and resin allows screws and nails to be used in their normal manner.

The bench top 100 can be made with different stones such as gravel, limestone, glass, shells or the like to provide different finishes. Further, the bench top 100 has good temperature behaviour, there is little limitation to colours as different pigments are able to be added to the resin, is easy to clean, is wear resistant, is significantly lighter than stone bench tops, its strength can be tailored to requirement by including extra reinforcement members, is inexpensive to manufacture and virtually any shape may be formed quickly and easy by changing the shape of the mould.

It should be appreciated that various other changes and modifications may be made to the embodiment described without departing from the spirit or scope of the invention.

1. A polymer concrete formulation comprising:
an amount of polymer resin;
an amount of thixotrope;
an amount of a light aggregate with a specific gravity less than that of the resin; and
an amount of a heavy aggregate with a specific gravity larger than that of the resin.

2. The polymer concrete formulation of claim 1 wherein the polymer resin is any suitable polyester, vinylester, epoxy or polyurethane resin or combination of resins.

3. The polymer concrete formulation of claim 1 wherein the polymer resin content is between 25-30% by volume.

4. The polymer concrete formulation of claim 1 wherein light aggregate has a specific gravity of 0.5 to 0.9.

5. The polymer concrete formulation of claim 1 wherein the light aggregates usually make up 20-25% by volume of the polymer concrete.

6. The polymer concrete formulation of claim 1 wherein the light aggregates are centre spheres.

7. The polymer concrete formulation of claim 6 wherein the centre spheres has a specific gravity of approximately 0.7.

8. The polymer concrete of claim 1 wherein the light aggregate is hollow glass microspheres.

9. The polymer concrete of claim 1 wherein the heavy aggregate makes up 40-60% by volume of the polymer concrete.

10. The polymer concrete of claim 1 wherein the heavy aggregate is basalt.

11. The polymer concrete of claim 10 wherein the basalt is crushed.

12. The polymer concrete of claim 10 wherein the basalt has a particle size between 5 to 7 mm.

13. The polymer concrete of claim 10 where the basalt makes up between 40-50% by volume of the polymer concrete.

14. The polymer concrete of claim 10 wherein the basalt has a specific gravity of approximately 2.8.

15 The polymer concrete of claim 1 wherein the heavy aggregate is sand having a specific gravity of approximately 2.8.

16. The polymer concrete of claim 15 wherein sand makes up between 50-60% by volume of the polymer concrete.

17. The polymer concrete of claim 1 wherein the heavy aggregate is made up of one or more of coloured stones, gravel, limestone, shells or glass.

18. The polymer concrete of claim 1 wherein the amount of thixotrope is between 0.5% to 1.0% by weight of the resin.

19. The polymer concrete of claim 1 wherein the thixotrope is fumed silica.

20. The polymer concrete of claim 1 also including fibrous reinforcement material.

21. The polymer concrete of claim 20 wherein the reinforcement material is one or more of glass, aramid, carbon, timber and/or thermo plastic fibres.

22. A method of forming a structural element using polymer concrete, the polymer concrete having an amount of polymer resin, an amount of thixotrope, an amount of a light aggregate with a specific gravity less than that of the resin; and an amount of a heavy aggregate with a specific gravity larger than that of the resin, the method including the steps of:
choosing an amount of resin;
choosing an amount of thixotrope;
choosing an amount of light aggregate to obtain the desired viscosity of the resin-light aggregate mix
choosing an amount of heavy aggregate to form a desired thickness of a lower layer within the structural element;
mixing the resin, thixotrope, heavy aggregate and light aggregate together to form polymer concrete;
locating the polymer concrete in a mould;
allowing the polymer concrete to settle to form a first layer and a second layer of different consistency within the structural element;
removing the structural element from the mould.

23. The method of claim 22 wherein reinforcement members are located within the polymer concrete after the polymer concrete has settled.

24. The method of claim 23 wherein the reinforcement members are located in the second layer of the structural element.

25. The method of claim 24 wherein the reinforcement members have a series of apertures located through the reinforcement member to allow resin and light aggregate to pass through the apertures.

26. The method of claim 23 wherein an additional mixture of resin and light aggregate may be located on top of the reinforcement member.

27. The method of claim 22 wherein a top surface of the first layer is polished.

28. A structural element comprising:
a first layer of:
an amount of polymer resin;
an amount of a light aggregate with a specific gravity less than that of the resin; and
an amount of a heavy aggregate with a specific gravity larger than that of the resin and;
a second layer of:
an amount of polymer resin; and
an amount of a light aggregate with a specific gravity less than that of the resin.

29. The structural element of claim 28 wherein one or more reinforcement members are located within the structural element.

30. The structural element of claim 29 wherein the reinforcement members are located between the first layer and the second layer.

31. The structural element of claim 30 wherein the reinforcement member has a series of apertures located through the reinforcement member.

32. The structural element of claim 31 wherein the apertures are sized to allow resin and an amount of light aggregate to pass through the apertures.
